(19) United States
(12) Patent Application Publication
(10) Pub. No.: US 2024/0246573 A1
(43) Pub. Date: Jul. 25, 2024

(54) MAJOR-MINOR INTERSECTION PREDICTION USING TRAFFIC SIGN FEATURES

(71) Applicant: GM Cruise Holdings LLC, San Francisco, CA (US)

(72) Inventors: Thanard Kurutach, Carrboro, NC (US); Chenyi Chen, Belmont, CA (US); Ou Jin, Redwood City, CA (US)

(21) Appl. No.: 18/158,162

(22) Filed: Jan. 23, 2023

(51) Int. Cl. B60W 60/00; B60W 30/18

(52) U.S. Cl. CPC B60W 60/0027; B60W 30/18154; B60W 2552/05; B60W 2555/60

(57) ABSTRACT

The disclosed technology provides solutions for determining, by an autonomous vehicle, whether to yield to a target vehicle at a major-minor intersection based on an estimated trajectory for the target vehicle and road sign data. A method comprising: navigating an autonomous vehicle (AV) along a first roadway, wherein the first roadway intersects with a second roadway; receiving, by the AV, road data indicative of at least one road sign on the first roadway; updating a prediction model based on the received road data; implementing the prediction model to determine an estimated trajectory for a target vehicle on the second roadway; and updating a planned trajectory of the AV based on the estimated trajectory for the target vehicle. Systems and machine-readable media are also provided.

### BACKGROUND

### 1. Technical Field

The disclosed technology provides solutions for determining, by an autonomous vehicle (AV), whether to yield to an oncoming (target) vehicle at an intersection and in particular, for determining when to yield a major-minor intersection based on an estimated trajectory for the target vehicle and road sign data.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 is a perspective view of an example autonomous vehicle (AV) travelling along a first roadway that intersects a second roadway with a target vehicle, according to some aspects of the disclosed technology.

FIG. 2 illustrates a conceptual flow of an AV software stack for processing road sign data, according to some aspects of the disclosed technology.

FIG. 3 illustrates an example process for updating a planned trajectory of the AV based on the estimated trajectory for the target vehicle, according to some aspects of the disclosed technology.

FIG. 4 is an illustrative example of a deep learning neural network that can be used to facilitate AV decision making, e.g., to determine whether to yield an AV to a target vehicle based on road sign data, according to some aspects of the disclosed technology.

FIG. 5 illustrates an example system environment that can be used to facilitate AV dispatch and operations, according to some aspects of the disclosed technology.

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

In some driving scenarios, it can be difficult for AVs to accurately predict whether to yield to potentially oncoming traffic, or to assert by navigating onto, or across, a roadway carrying the oncoming traffic flow. Such scenarios often arise when an AV is required to navigate through a major-minor intersection, for example, in which the AV is navigating on a smaller (minor) roadway that intersects with one or more larger (major) roadway/s. In some scenarios, ‘major’ or ‘minor’ road designations may be made (or determined) based on signage presented on either (or both) intersecting roadways. By way of example, where two or more roads intersect, the minor road can have a stop sign (or a yield sign) that is not present on the major road. Depending on the roadway topology, major/minor roadways may be distinguished based on a variety of other factors. For example, a minor road can have fewer lanes than a major road, a minor road can have a slower speed limit than a major road, and/or a minor road can have less traffic than a major road, etc.

However, in the special case of minor-major intersections, traffic flowing on the major-road is unlikely to slow or yield to approaching vehicles from the minor-road. For example, a vehicle travelling at a high rate of speed on a highway is unlikely to slow down as it encounters an intersection with a dirt country road when the highway has no signage while the dirt country road has a stop sign. That is, the driver of the vehicle travelling on the highway will understand that they have the right-of-way, and that any vehicles travelling on the intersecting country road (with the stop sign) will stop and/or yield to the vehicle travelling on the highway. In such scenarios, the minor roadway is often marked with road signs (e.g., yield or stop signs) indicating that merging traffic should yield to oncoming major-roadway traffic.

However, current AVs do not consider whether the AV is travelling on a major road or a minor road when predicting the actions of vehicles (also referred to herein as target vehicles) traveling on an intersecting major roadway. Therefore, an AV travelling on a minor road, approaching an intersection of a major road, may (erroneously) predict that a vehicle traveling on the major road will slow down as it approaches the intersection. In the situation where the AV plans to turn onto the major road from the minor road, the AV will assert itself in front of the oncoming vehicles on the major road when the AV should instead yield to the oncoming traffic instead. That is, the AV predicts (sometimes erroneously) that the vehicle traveling on the major roadway will slow down as it approaches the minor roadway, and therefore the AV will determine that it has sufficient time and space to assert in front of the vehicle traveling on the second roadway.

Often vehicles traveling on the major roadway will not expect another vehicle to assert in front of them. Because asserting the AV in front of oncoming vehicles travelling at high rates of speed can be a safety hazard, there exists a need to improve the operation of the AV so that the AV can make better decisions about asserting or yielding to vehicles traveling on a major roadway.

Aspects of the disclosed technology provide solutions for improving AV predictions about the behavior of oncoming (or target) vehicles, e.g., by improving determinations about whether to yield to an oncoming (target) vehicle at an intersection and in particular, for determining when to yield a major-minor intersection based on an estimated trajectory for the target vehicle and road sign data.

In some examples, the AV can determine whether it is traveling on a major or a minor road and whether the road at the approaching intersection is a major or minor road. In some examples, when the AV determines that it is travelling on a minor road and approaching a major road it can use this information to yield to the vehicles travelling on the major road. That is, the AV can determine whether it is traveling on a major or minor road and whether the second roadway intersecting the roadway that the AV is traveling on is a major or minor road based on determining which roadways have signage located at the intersection. In some examples, the roadway comprising a sign (such as a stop sign or a yield sign, for example) can be defined as a minor roadway, while the roadway that lacks a sign can be defined as a major roadway.

In some examples, when an AV travelling on a minor roadway approaches a sign positioned proximate to a major roadway, the sensors mounted on the AV can sense the existence of the sign and provide the data to the AV's computing system which can subsequently instruct the AV to obey the signage. For example, if the AV approaches a stop sign, the sensors will capture data indicating that the AV is approaching a stop sign, and subsequently the AV's computing system can instruct the AV to stop at the stop sign. In some examples, the existence of a sign can be sensed by sensor mounted on other AVs traveling in the same area and this data can be communicated the AV.

As described in more detail below, a planning layer within the AV's computing system can determine one or more mechanical operations that the AV can perform (e.g., stop at a stop sign, or ignore a stop sign), and select the best one to meet road conditions and events. Specifically, when a sensor mounted on an AV detects a stop sign, this data is provided to the planning layer of the AV's computing system, which subsequently instructs the AV to obey the stop sign and stop the AV at the stop sign.

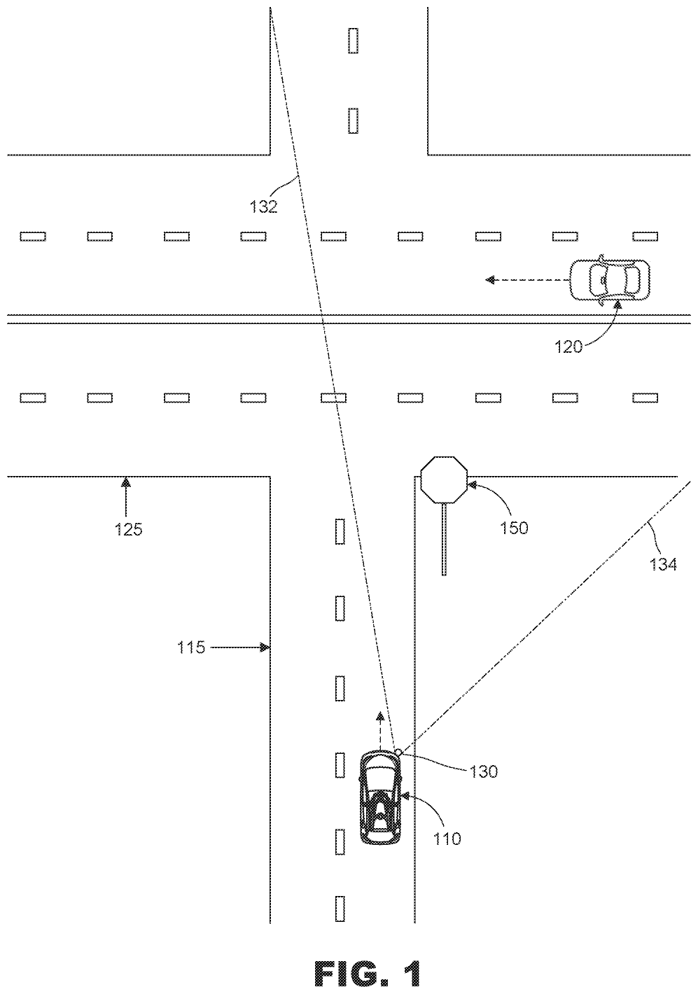

FIG. 1 is a perspective view of an example AV 110 travelling along a first roadway 115 (in the direction indicated by the arrow) that intersects a second roadway 125 with a target vehicle 120 (traveling in the direction indicated by the arrow). In some examples, AV 110 can comprise a sensor 130 with a field of view (FOV) located between dotted line 132 and dotted line 134. Although not illustrated in FIG. 1, in some examples, AV 110 can comprise multiple sensors. As discussed in more detail below, AV 110 can comprise multiple sensor systems, including different types of sensors arranged about the AV 110. For instance, the sensor systems can include, but are not limited to, one or more: Inertial Measurement Units (IMUs), cameras (e.g., still image cameras, video cameras, etc.), optical sensors (e.g., LIDAR systems, ambient light sensors, infrared sensors, etc.), Radio Detection and Ranging (RADAR) systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. Other embodiments may include any other number and type of sensors.

As illustrated in FIG. 1, the first roadway 115 can be defined as a “minor” roadway, while the second roadway 125 can be defined as a “major” roadway. In this example, the first roadway 115 comprises two lanes while the second roadway 125 comprises four lanes. In some examples, as described above, a first roadway with fewer lanes than a second roadway can be considered a minor roadway, while the second roadway can be considered a major roadway. The distinction between a “minor” roadway and a “major” roadway is not limited to two lanes or four lanes, and any other number of lanes can distinguish a minor road from a major road. While FIG. 1 illustrates that the minor road and major road are distinguished at least based on the number of lanes of each roadway, other factors can also distinguish between a minor road and a major road. For example, a minor road may have a lower speed limit, less traffic, or different surface material, among other differences, than a major road.

FIG. 1 further illustrates that first roadway 115 includes a sign 150 positioned proximate the intersection of the second roadway 125. While FIG. 1 shows that sign 150 is a stop sign, the method described herein also applies when sign 150 is a yield sign and/or another sign indicating an instruction to yield to oncoming traffic. As described in more detail below, sensor 130 collects data within the FOV located between dotted line 132 and dotted line 134 to help guide the operation of AV 110. In some examples, as AV 110, traveling on first roadway 115, approaches the intersection of second roadway 125, the sensor 130 of AV 110 captures data regarding the items located within the FOV between dotted line 132 and dotted line 134 and provides this captured data to the local computing device located within AV 110.

In some examples, as AV 110 approaches the intersection of the first roadway 115 and the second roadway 125, the AV 110 can use sensor data collected by sensor 130 to detect the sign 150. As discussed above, in some examples, the planning layer of AV 110's computing system can instruct the AV to obey the sign 150. For example, if sign 150 is a stop sign, the planning layer of AV 110's computing system can instruct AV 110 to stop proximate to the stop sign. In some examples, once the AV 110 has stopped at the stop sign 150, the prediction layer of AV 110's computing system can predict a future path for the target vehicle 120 (detected by AV 110's sensors) in order to determine when the stopped AV 110 should assert to turn onto second roadway 125 and avoid a collision with target vehicle 120.

In some examples, the prediction layer of the AV 110's computing system can improve the prediction of the future paths for target vehicle 120 by accounting for whether the AV 110 is located on a major road or a minor road and whether the target vehicle 120 is traveling on a major road or a minor road. As discussed above, in some examples, vehicles traveling on a major road and passing a minor road intersection are unlikely to slow down; in contrast vehicles traveling on a road intersecting with a similar road are likely to slow down when approaching the intersection. Therefore, in some examples, the prediction layer can account for the major/minor road characterizations when predicting the future paths for target vehicle 120.

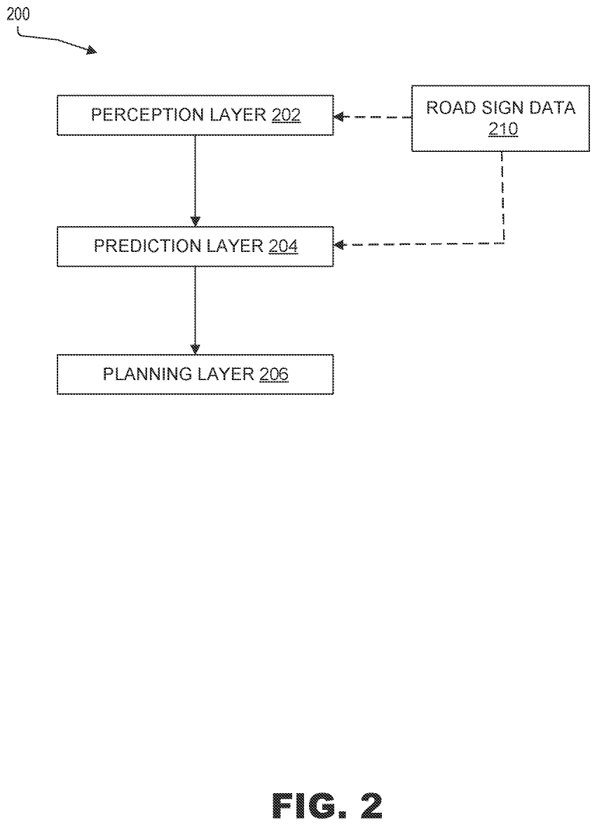

In some examples, the prediction layer of AV 110's computing system can determine whether the AV is on a major road or a minor road and whether the intersecting second road is a major road or a minor road based on the sign data captured by the sensor 130. Specifically, the sensor 130 can capture the sign 150 and provide that data to the prediction layer of AV 110's computing system. In some examples, when a sign is detected on the roadway that the AV 110 is traveling, but no sign is detected on the roadway that the target vehicle 120 is traveling, the prediction layer can determine that the AV 110 is traveling on a minor road, while the target vehicle 120 is traveling on a major road. In some examples, if the prediction layer of the AV 110's computing device determines that the AV 110 is traveling on a minor road 115 and the target vehicle 120 is traveling on a major road 125, the prediction layer will account for this fact when predicting the predicted trajectories of the target vehicle 120 and therefore not predict that target vehicle 120 will slow down as it approaches the intersection. As discussed below, with reference to FIG. 2, the prediction layer can subsequently provide this prediction of target vehicle 120's future behavior to the planning layer, which will consider that the target vehicle 120 is not likely to slow down and therefore AV 110 should yield to the target vehicle 120, and pull behind it rather than assert in front of target vehicle 120.

FIG. 2 illustrates a conceptual flow of an AV software stack 200 for processing road sign data, according to some examples of the present disclosure. Specifically, the example AV software stack shown in FIG. 2 includes a perception layer 202, a prediction layer 204, and a planning layer 206. The perception layer 202 functions to access sensor data gathered by the AV. From the sensor data, the perception layer 202 can identify and track objects. Specifically, the perception layer 202 can identify where tracked objects are in a field of view relative to the AV. For example, the perception layer 202 can receive road sign data 210 from any of the sensors mounted on the AV 110 and subsequently identify that sign 150 is a stop sign.

The prediction layer 204 functions to predict where objects will be in a field of view. For example, the prediction layer 204 can predict the future location of target vehicle 120. The prediction layer 204 can predict the location of objects based on the tracked object output of the perception layer 202. In some examples, the road sign data 210 can be communicated to the prediction layer 204 via the output of the perception layer 202 as indicated by the arrow. In some examples, the road sign data 210 can be communicated directly to the prediction layer 204 as indicated by the dotted arrow. In some examples, this road sign data can be used by the prediction layer 204 to determine whether the AV 110 is traveling on a major road or a minor road and whether the second intersecting road is a minor or major road. This determination can be used by the prediction layer 204 to improve the prediction of the future location of the target vehicle 120, thereby assisting in determining whether the AV 110 should assert or yield to the approaching target vehicle 120. For example, if the prediction layer 204 determines that the target vehicle 120 will not slow down at the intersection (based on the identified road sign data 210 received from the perception layer 202), this information can be subsequently used by the AV 110's computing system to yield the AV 110 to the target vehicle 120 rather than assert in front of target vehicle 120.

The planning layer 206 functions to identify a path for the AV. Specifically, the planning layer 206 functions to identify a path for the AV based on either or both the output of the perception layer 202 and the prediction layer 204. In identifying a path for the AV, the planning layer 206 can weigh various moves by the AV against costs with respect to the output of either or both the perception layer 202 and the prediction layer 204. For example, if the prediction layer 204 has predicted that target vehicle 120 will likely not slow down at the intersection (if the target vehicle is traveling on a major road, for example), the planning layer 206 will weigh this fact when determining whether to plan to assert or yield the AV 110 to target vehicle 120.

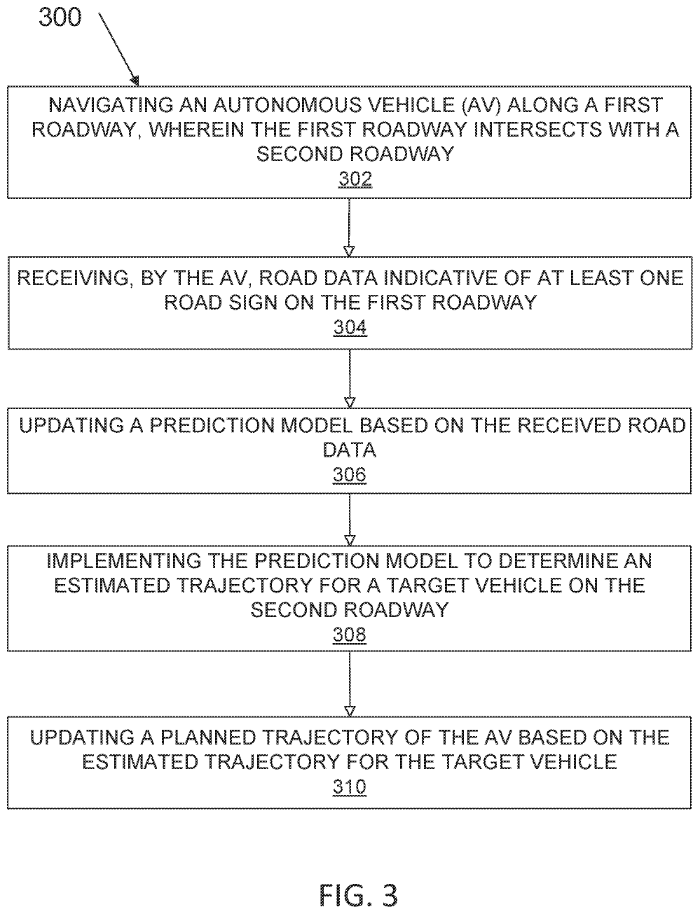

FIG. 3 illustrates a process 300 for updating a planned trajectory of the AV based on the estimated trajectory for the target vehicle, according to some aspects of the disclosed technology. At block 302, the process 300 can include navigating an AV (e.g., AV 110) along a first roadway (e.g., first roadway 115), wherein the first roadway intersects with a second roadway (e.g., second roadway 125). As illustrated in FIG. 1, in some examples, the first roadway 115 can be a “minor” roadway, while the second roadway 125 can be a “major” roadway. As shown in this example, the first roadway 115 comprises two lanes while the second roadway 125 comprises four lanes.

At block 304, the process 300 can include receiving, by the AV (e.g., AV 110), road data indicative of at least one road sign (e.g., sign 150) on the first roadway (e.g., first roadway 115). In some examples, AV 110 can comprise a sensor 130 with a field of view (FOV) located between dotted line 132 and dotted line 134. Other embodiments may include any other number and type of sensors. In some examples, as AV 110 approaches the intersection of the first roadway 115 and the second roadway 125, the sensor 130 mounted on AV 110 can detect the sign 150 and the target vehicle 120. In some examples, sign 150 can be a stop sign. In some examples, sign 150 can be a yield sign. In some examples, the road data corresponds with the target vehicle 120 travelling on the second roadway 125 and at least one road sign located on the second roadway.

At block 306, the process 300 can include updating a prediction model based on the received road data. And, subsequently, at block 308, the process 300 can include implementing the prediction model to determine an estimated trajectory for a target vehicle (e.g., target vehicle 120) on the second roadway. In some examples, updating a prediction model based on the received road data and implementing the prediction model to determine an estimated trajectory for a target vehicle comprises providing the road data to a prediction layer of the AV, wherein the prediction layer is configured to use the road data to generate the estimated trajectory for the target vehicle. As described above, the prediction layer 204 can predict a future path for objects detected by the AV's sensors. In some examples, the prediction layer can output several likely paths that a sensed object (e.g., target vehicle 120) is predicted to take along with a probability associated with each path. In some examples, once the AV 110 has stopped at the stop sign 150, the prediction layer of AV 110's computing system can predict a future path for the target vehicle 120 (detected by AV 110's sensors) in order to subsequently determine when the stopped AV 110 should assert to turn onto second roadway 125 and avoid a collision with target vehicle 120.

At block 308, the process 300 can include updating a planned trajectory of the AV (e.g., AV 110) based on the estimated trajectory for the target vehicle (e.g., target vehicle 120). In some examples, the prediction layer of AV 110's computing system can determine whether the AV is on a major road or a minor road and whether the intersecting second road is a major road or a minor road based on the sign data captured by the sensor 130. Specifically, the sensor 130 can capture the sign 150 and provide that data to the prediction layer of AV 110's computing system. In some examples, when a sign is detected on the roadway that the AV 110 is traveling, but no sign is detected on the roadway that the target vehicle 120 is traveling, the prediction layer can determine that the AV 110 is traveling on a minor road, while the target vehicle 120 is traveling on a major road. In some examples, if the prediction layer of the AV 110's computing device determines that the AV 110 is traveling on a minor road 115 and the target vehicle 120 is traveling on a major road 125, the prediction layer will not predict that the target vehicle 120 will slow down. As discussed above, with reference to FIG. 2, the prediction layer can subsequently provide this prediction of target vehicle 120's future behavior to the planning layer, which will consider that the target vehicle 120 is not likely to slow down and therefore AV 110 should yield to the target vehicle 120, and pull behind it rather than assert in front of target vehicle 120.

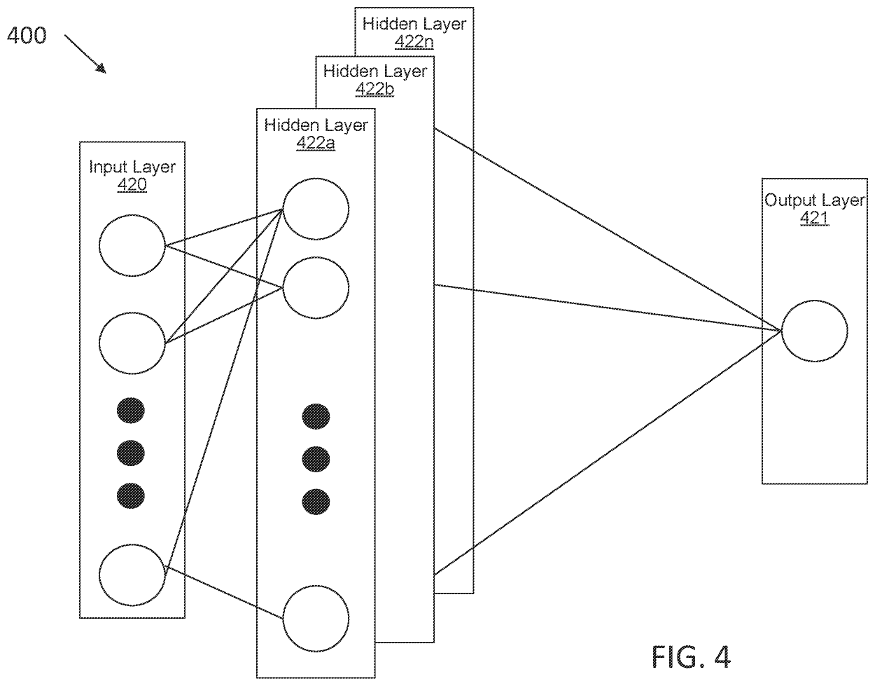

FIG. 4 is an illustrative example of a deep learning neural network 400 that can be implemented as part of the prediction layer to determine whether to yield an AV to a target vehicle at a major-minor intersection based on an estimated trajectory for the target vehicle and road sign data. An input layer 420 includes input data. In one illustrative example, the input layer 420 can be configured to receive road sign data. The neural network 400 includes multiple hidden layers 422a, 422b, through 422n. The hidden layers 422a, 422b, through 422n include “n” number of hidden layers, where “n” is an integer greater than or equal to one. The number of hidden layers can be made to include as many layers as needed for the given application. The neural network 400 further includes an output layer 421 that provides an output resulting from the processing performed by the hidden layers 422a, 422b, through 422n. In some examples, the predicted trajectory of the target vehicle is provided at the output layer.

The neural network 400 is a multi-layer neural network of interconnected nodes. Each node can represent a piece of information. Information associated with the nodes is shared among the different layers and each layer retains information as information is processed. In some cases, the neural network 400 can include a feed-forward network, in which case there are no feedback connections where outputs of the network are fed back into itself. In some cases, the neural network 400 can include a recurrent neural network, which can have loops that allow information to be carried across nodes while reading in input.

Information can be exchanged between nodes through node-to-node interconnections between the various layers. Nodes of the input layer 420 can activate a set of nodes in the first hidden layer 422a. For example, as shown, each of the input nodes of the input layer 420 is connected to each of the nodes of the first hidden layer 422a. The nodes of the first hidden layer 422a can transform the information of each input node by applying activation functions to the input node information. The information derived from the transformation can then be passed to and can activate the nodes of the next hidden layer 422b, which can perform their own designated functions. Example functions include convolutional, up-sampling, data transformation, and/or any other suitable functions. The output of the hidden layer 422b can then activate nodes of the next hidden layer, and so on. The output of the last hidden layer 422n can activate one or more nodes of the output layer 421, at which an output is provided. In some cases, while nodes (e.g., node 426) in the neural network 400 are shown as having multiple output lines, a node can have a single output and all lines shown as being output from a node represent the same output value.

In some cases, each node or interconnection between nodes can have a weight that is a set of parameters derived from the training of the neural network 400. Once the neural network 400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 400 to be adaptive to inputs and able to learn as more and more data is processed.

The neural network 400 is pre-trained to process the features from the data in the input layer 420 using the different hidden layers 422a, 422b, through 422n in order to provide the output through the output layer 421. In some cases, the neural network 400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 400 is trained well enough so that the weights of the layers are accurately tuned.

A loss function can be used to analyze error in the output. Any suitable loss function definition can be used, such as a Cross-Entropy loss. Another example of a loss function includes the mean squared error (MSE), defined as E_total=Σ(½(target−output)²). The loss can be set to be equal to the value of E_total. The goal of training is to minimize the amount of loss so that the predicted output is the same as the training label. The neural network 400 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i·n dL/dW, where w denotes a weight, wi denotes the initial weight, and n denotes a learning rate. The learning rate can be set to any suitable value, with a high learning rate including larger weight updates and a lower value indicating smaller weight updates.

The neural network 400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 400 can include any other deep network other than a CNN, such as an autoencoder, a deep belief nets (DBNs), a Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

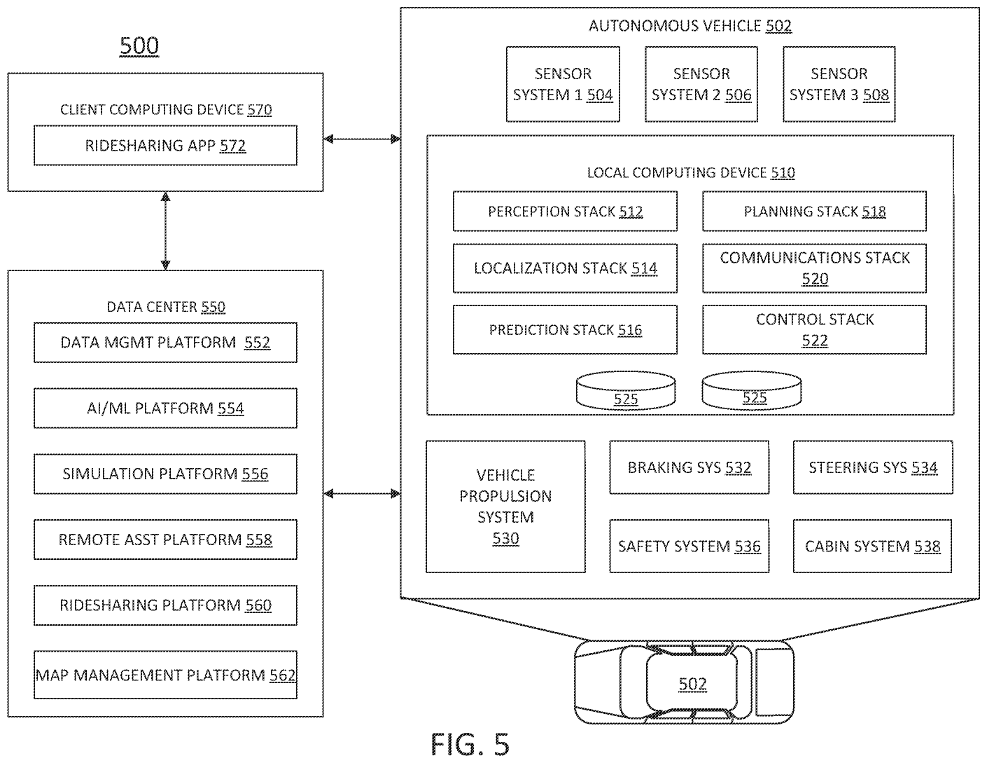

FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 150, and a client computing device 170. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some embodiments, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a prediction stack 516, a planning stack 518, a communications stack 520, a control stack 522, an AV operational database 524, and an HD geospatial database 526, among other stacks and systems.

The perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 526, other components of the AV, and other data sources (e.g., the data center 550, the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 514 can determine the AV's position and orientation (pose) using different methods from multiple systems (e.g., GPS, IMUs, cameras, LIDAR, RADAR, ultrasonic sensors, the HD geospatial database 526, etc.). For example, in some embodiments, AV 502 can compare sensor data captured in real-time by sensor systems 504-508 to data in HD geospatial database 526 to determine its precise (e.g., accurate to the order of a few centimeters or less) position and orientation. AV 502 can focus its search based on sensor data from one or more first sensor systems (e.g., GPS) by matching sensor data from one or more second sensor systems (e.g., LIDAR). If the mapping and localization information from one system is unavailable, AV 502 can use mapping and localization information from a redundant system and/or from remote data sources.

Prediction stack 516 can receive information from localization stack 514 and objects identified by perception stack 512 and predict a future path for the objects. In some embodiments, prediction stack 516 can output several likely paths that an object is predicted to take along with a probability associated with each path. For each predicted path, prediction stack 516 can also output a range of points along the path corresponding to a predicted location of the object along the path at future time intervals along with an expected error value for each of the points that indicates a probabilistic deviation from that point.

Planning stack 518 can determine how to maneuver or operate AV 502 safely and efficiently in its environment. For example, planning stack 518 can receive the location, speed, and direction of AV 502, geospatial data, data regarding objects sharing the road with AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, localization stack 514, and prediction stack 516. Planning stack 518 can determine multiple sets of one or more mechanical operations that AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct AV 502 to go around the block instead of blocking a current lane while waiting for an opening to change lanes.

Control stack 522 can manage the operation of the vehicle propulsion system 530, the braking system 532, the steering system 534, the safety system 536, and the cabin system 538. Control stack 522 can receive sensor signals from the sensor systems 504-508 as well as communicate with other stacks or components of the local computing device 510 or a remote system (e.g., the data center 550) to effectuate operation of AV 502. For example, control stack 522 can implement the final path or actions from the multiple paths or actions provided by planning stack 518. This can involve turning the routes and decisions from planning stack 518 into commands for the actuators that control the AV's steering, throttle, brake, and drive unit.

Communications stack 520 can transmit and receive signals between the various stacks and other components of AV 502 and between AV 502, data center 550, client computing device 570, and other remote systems. Communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 526 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 524 can store raw AV data generated by the sensor systems 504-508, stacks 512-522, and other components of AV 502 and/or data received by AV 502 from remote systems (e.g., data center 550, client computing device 570, etc.). In some embodiments, the raw AV data can include HD LIDAR point cloud data, image data, RADAR data, GPS data, and other sensor data that data center 550 can use for creating or updating AV geospatial data or for creating simulations of situations encountered by AV 502 for future testing or training of various machine learning algorithms that are incorporated in local computing device 510.

Data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 550 can include one or more computing devices remote to local computing device 510 for managing a fleet of AVs and AV-related services. For example, in addition to managing AV 502, data center 550 may also support a ridesharing service, a delivery service, a remote/roadside assistance service, street services (e.g., street mapping, street patrol, street cleaning, street metering, parking reservation, etc.), and the like.

Data center 550 can send and receive various signals to and from AV 502 and client computing device 570. These signals can include sensor data captured by the sensor systems 504-508, roadside assistance requests, software updates, ridesharing pick-up and drop-off instructions, and so forth. In this example, data center 550 includes a data management platform 552, an Artificial Intelligence/Machine Learning (AI/ML) platform 554, a simulation platform 556, a remote assistance platform 558, and a ridesharing platform 560, and a map management platform 562, among other systems.

Data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

AI/ML platform 554 can provide the infrastructure for training and evaluating machine learning algorithms for operating AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

Simulation platform 556 can enable testing and validation of the algorithms, machine learning models, neural networks, and other development efforts for AV 502, remote assistance platform 558, ridesharing platform 560, map management platform 562, and other platforms and systems. The simulation platform 556 can replicate a variety of driving environments and/or reproduce real-world scenarios from data captured by AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

Remote assistance platform 558 can generate and transmit instructions regarding the operation of the AV 502. For example, in response to an output of the AI/ML platform 554 or other system of data center 550, remote assistance platform 558 can prepare instructions for one or more stacks or other components of AV 502.

Ridesharing platform 560 can interact with a customer of a ridesharing service via a ridesharing application 572 executing on client computing device 570. The client computing device 570 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 572. Client computing device 570 can be a customer's mobile computing device or a computing device integrated with the AV 502 (e.g., the local computing device 510). The ridesharing platform 560 can receive requests to pick up or drop off from the ridesharing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of data center 550. For example, the AI/ML platform 554 may incorporate the map viewing services for visualizing the effectiveness of various object detection or object classification models, simulation platform 556 may incorporate the map viewing services for recreating and visualizing certain driving scenarios, remote assistance platform 558 may incorporate the map viewing services for replaying traffic incidents to facilitate and coordinate aid, ridesharing platform 560 may incorporate the map viewing services into client application 572 to enable passengers to view AV 502 in transit en route to a pick-up or drop-off location, and so on.

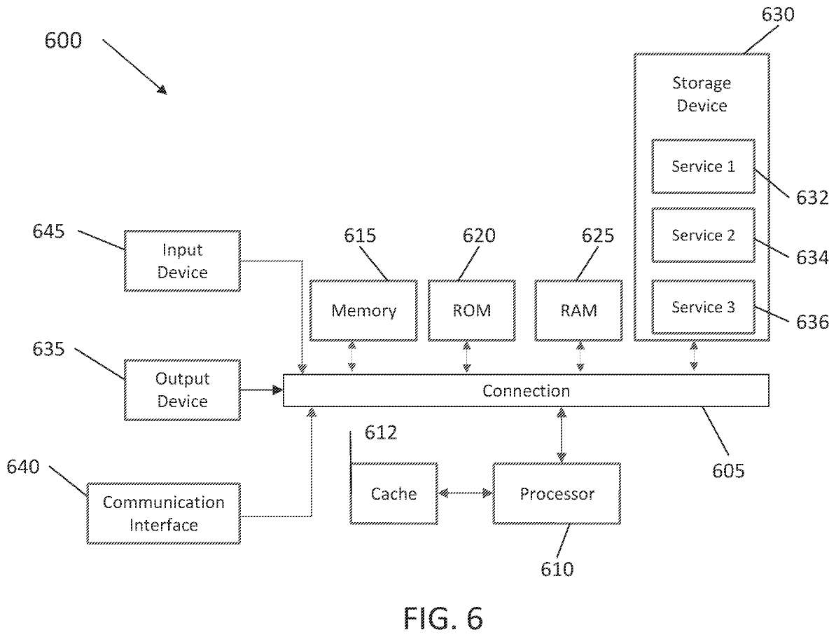

FIG. 6 illustrates an example apparatus (e.g., a processor-based system) with which some aspects of the subject technology can be implemented. For example, processor-based system 600 can be any computing device making up internal computing system 510, remote computing system 550, a passenger device executing the rideshare app 570, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

Computing system 600 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Aspect 1. A method comprising: navigating an autonomous vehicle (AV) along a first roadway, wherein the first roadway intersects with a second roadway; receiving, by the AV, road data indicative of at least one road sign on the first roadway; updating a prediction model based on the received road data; implementing the prediction model to determine an estimated trajectory for a target vehicle on the second roadway; and updating a planned trajectory of the AV based on the estimated trajectory for the target vehicle.

Aspect 2. The method of Aspect 1, wherein the at least one road sign is a stop sign or a yield sign.

Aspect 3. The method of Aspect 1 or 2, wherein the road data corresponds with the target vehicle travelling on the second roadway and at least one second road sign on the second roadway.

Aspect 4. The method of any of Aspects 1 to 3, wherein determining the estimated trajectory for the target vehicle based on the road data further comprising: providing the road data to a prediction layer of the AV, wherein the prediction layer is configured to use the road data to generate the estimated trajectory for the target vehicle.

Aspect 5. The method of any of Aspects 1 to 4, wherein the AV receives the road data from sensors mounted on the AV.

Aspect 6. The method of any of Aspects 1 to 5, wherein the AV receives the road data from the target vehicle.

Aspect 7. The method of Aspect 6, wherein the AV receives the road data from sensors mounted on the AV.

Aspect 8. A system comprising: one or more processors; and at least one computer-readable storage medium having stored therein instructions which, when executed by the one or more processors, cause the one or more processors to: navigate an autonomous vehicle (AV) along a first roadway, wherein the first roadway intersects with a second roadway; receive, by the AV, road data indicative of at least one road sign on the first roadway; update a prediction model based on the received road data; implement the prediction model to determine an estimated trajectory for a target vehicle on the second roadway; and update a planned trajectory of the AV based on the estimated trajectory for the target vehicle.

Aspect 9. The system of Aspect 8, wherein the at least one road sign is a stop sign or a yield sign.

Aspect 10. The system of Aspect 8 or 9, wherein the road data corresponds with the target vehicle travelling on the second roadway and at least one second road sign on the second roadway.

Aspect 11. The system of any of Aspects 8 to 10, wherein determining the estimated trajectory for the target vehicle based on the road data further comprising: providing the road data to a prediction layer of the AV, wherein the prediction layer is configured to use the road data to generate the estimated trajectory for the target vehicle.

Aspect 12. The system of any of Aspects 8 to 11, wherein the AV receives the road data from sensors mounted on the AV.

Aspect 13. The system of any of Aspects 8 to 12, wherein the AV receives the road data from the target vehicle.

Aspect 14. The system of Aspect 13, wherein the AV receives the road data from sensors mounted on the AV.

Aspect 15. A non-transitory computer-readable storage medium comprising at least one instruction for causing a computer or processor to: navigate an autonomous vehicle (AV) along a first roadway, wherein the first roadway intersects with a second roadway; receive, by the AV, road data indicative of at least one road sign on the first roadway; update a prediction model based on the received road data; implement the prediction model to determine an estimated trajectory for a target vehicle on the second roadway; and update a planned trajectory of the AV based on the estimated trajectory for the target vehicle.

Aspect 16. The non-transitory computer-readable storage medium of Aspect 15, wherein the at least one road sign is a stop sign or a yield sign.

Aspect 17. The non-transitory computer-readable storage medium of Aspect 15 or 16, wherein the road data corresponds with the target vehicle travelling on the second roadway and at least one second road sign on the second roadway.

Aspect 18. The non-transitory computer-readable storage medium of any of Aspects 15 to 17, wherein determining the estimated trajectory for the target vehicle based on the road data further comprising: providing the road data to a prediction layer of the AV, wherein the prediction layer is configured to use the road data to generate the estimated trajectory for the target vehicle.

Aspect 19. The non-transitory computer-readable storage medium of any of Aspects 15 to 18, wherein the AV receives the road data from sensors mounted on the AV.

Aspect 20. The non-transitory computer-readable storage medium of any of Aspects 15 to 18, wherein the AV receives the road data from the target vehicle.

What is claimed is:

1. A method comprising:
navigating an autonomous vehicle (AV) along a first roadway, wherein the first roadway intersects with a second roadway;
receiving, by the AV, road data indicative of at least one road sign on the first roadway;
updating a prediction model based on the received road data;
implementing the prediction model to determine an estimated trajectory for a target vehicle on the second roadway; and
updating a planned trajectory of the AV based on the estimated trajectory for the target vehicle.

2. The method of claim 1, wherein the at least one road sign is a stop sign or a yield sign.

3. The method of claim 1, wherein the road data corresponds with the target vehicle travelling on the second roadway and at least one second road sign on the second roadway.

4. The method of claim 1, wherein determining the estimated trajectory for the target vehicle based on the received road data further comprising:
providing the road data to a prediction layer of the AV, wherein the prediction layer is configured to use the road data to generate the estimated trajectory for the target vehicle.

5. The method of claim 1, wherein the AV receives the road data from sensors mounted on the AV.

6. The method of claim 1, wherein the AV receives the road data from the target vehicle.

7. The method of claim 6, wherein the AV receives the road data from sensors mounted on the AV.

8. A system comprising:
one or more processors; and
at least one computer-readable storage medium having stored therein instructions which, when executed by the one or more processors, cause the one or more processors to:
navigate an autonomous vehicle (AV) along a first roadway, wherein the first roadway intersects with a second roadway;
receive, by the AV, road data indicative of at least one road sign on the first roadway;
update a prediction model based on the received road data;
implement the prediction model to determine an estimated trajectory for a target vehicle on the second roadway; and
update a planned trajectory of the AV based on the estimated trajectory for the target vehicle.

9. The system of claim 8, wherein the at least one road sign is a stop sign or a yield sign.

10. The system of claim 8, wherein the road data corresponds with the target vehicle travelling on the second roadway and at least one second road sign on the second roadway.

11. The system of claim 8, wherein determining the estimated trajectory for the target vehicle based on the received road data further comprising:
providing the road data to a prediction layer of the AV, wherein the prediction layer is configured to use the road data to generate the estimated trajectory for the target vehicle.

12. The system of claim 8, wherein the AV receives the road data from sensors mounted on the AV.

13. The system of claim 8, wherein the AV receives the road data from the target vehicle.

14. The system of claim 13, wherein the AV receives the road data from sensors mounted on the AV.

15. A non-transitory computer-readable storage medium comprising at least one instruction for causing a computer or processor to:
navigate an autonomous vehicle (AV) along a first roadway, wherein the first roadway intersects with a second roadway;
receive, by the AV, road data indicative of at least one road sign on the first roadway;
update a prediction model based on the received road data;
implement the prediction model to determine an estimated trajectory for a target vehicle on the second roadway; and
update a planned trajectory of the AV based on the estimated trajectory for the target vehicle.

16. The non-transitory computer-readable storage medium of claim 15, wherein the at least one road sign is a stop sign or a yield sign.

17. The non-transitory computer-readable storage medium of claim 15, wherein the road data corresponds with the target vehicle travelling on the second roadway and at least one second road sign on the second roadway.

18. The non-transitory computer-readable storage medium of claim 15, wherein determining the estimated trajectory for the target vehicle based on the road data further comprising:
providing the road data to a prediction layer of the AV, wherein the prediction layer is configured to use the road data to generate the estimated trajectory for the target vehicle.

19. The non-transitory computer-readable storage medium of claim 15, wherein the AV receives the road data from sensors mounted on the AV.

20. The non-transitory computer-readable storage medium of claim 15, wherein the AV receives the road data from the target vehicle.
